(19) United States
(12) Patent Application Publication
(10) Pub. No.: US 2018/0171871 A1
(43) Pub. Date: Jun. 21, 2018

(54) Surface Cooler with Flow Recirculation

(71) Applicant: Pratt & Whitney Canada Corp., Longueuil (CA)

(72) Inventors: Hien Duong, Mississauga (CA); Vijay Kandasamy, Tamil Nadu (IN); Rakesh Muniyappa, Bangalore (IN)

(21) Appl. No.: 15/380,205

(22) Filed: Dec. 15, 2016

(51) Int. Cl. F02C 7/14; F02K 3/115; F02K 3/06; F02C 7/18

(52) U.S. Cl. CPC F02C 7/14; F02C 7/18; F02K 3/06; F02K 3/115

(57) ABSTRACT

A gas turbine engine that comprises an engine core having a compressor, a turbine, a combustor, and a rotation axis. The engine further comprising a fan case wall having a radially-inner surface, a by-pass duct between the fan case wall and around the engine core, a plurality of struts circumferentially distributed and extending across the by-pass duct, a surface cooler adjacent to the radially-inner surface of the fan case and configured to be exposed to a by-pass air flow through the by-pass duct during operation of the gas turbine engine, the surface cooler fluidly communicating with a fluid circuit of the engine requiring cooling for of a fluid, and a recirculation conduit extending between an inlet in the radially-inner surface of the fan case disposed downstream of the surface cooler and an outlet in the radially-inner surface of the fan case wall disposed upstream of the surface cooler.

### TECHNICAL FIELD

The application relates generally to gas turbine engine and, more particularly, to systems and method used to cool hot engine fluids.

### BACKGROUND OF THE ART

Gas turbine engines, more specifically turbofan engines, comprise a fan case having a by-pass duct for receiving an annular by-pass flow surrounding the engine core. During operation, the temperature of the annular by-pass flow can be sufficiently lower than the temperatures of the engine core that a surface cooler can be used to provide heat transfer between a hot engine fluid and colder air of the annular by-pass flow. Such hot engine fluid may be, for instance, lubricating fluids or oil from engine systems.

Surface coolers typically have a plurality of fins which are usually rectangular and protrude radially into the by-pass duct. Although the fins are disposed parallel to the annular by-pass flow, they generate drag and associated losses.

### SUMMARY

In one aspect, there is provided a gas turbine engine, comprising: an engine core having a compressor, a turbine, a combustor, and a rotation axis; a fan case wall extending circumferentially and having a radially-inner surface; a by-pass duct between the fan case wall and the engine core, a plurality of struts circumferentially distributed and extending across the by-pass duct; a surface cooler adjacent to the radially-inner surface of the fan case wall and configured to be exposed to a by-pass air flow through the by-pass duct during operation of the gas turbine engine, the surface cooler fluidly communicating with a fluid circuit of the engine requiring cooling of a fluid; and a recirculation conduit extending between an inlet in the radially-inner surface of the fan case wall disposed downstream of the surface cooler and an outlet in the radially-inner surface of the fan case wall disposed upstream of the surface cooler.

In another aspect, there is provided a fan case assembly of a gas turbine engine, comprising: a fan case wall circumferentially extending around a longitudinal axis of the gas turbine engine and having a radially-inner surface; a recirculation conduit circumferentially extending between an inlet and an outlet defined in the fan case wall, the inlet disposed downstream of the outlet, the recirculation conduit configured to deliver by-pass air from the inlet to the outlet; and a surface cooler mounted adjacent the radially-inner surface between the inlet and the outlet, the surface cooler communicating with a fluid circuit of the engine requiring cooling of a fluid.

In yet another aspect, there is provided a method for cooling an engine fluid circulating in an engine core of a gas turbine engine, comprising: receiving a by-pass flow in a by-pass duct defined by a fan case wall surrounding the engine core; transferring heat from the engine fluid to the by-pass flow by convection with a surface cooler adjacent to a radially-inner surface of the fan case wall; bleeding the by-pass flow downstream of the surface cooler through an outlet in the radially-inner surface; and recirculating an extracted portion of the by-pass flow and injecting it back into the by-pass flow at a position upstream of the surface cooler through an inlet in the radially-inner surface, the inlet being fluidly connected to the outlet by a recirculation conduit.

### DESCRIPTION OF THE DRAWINGS

Reference is now made to the accompanying figures in which:

FIG. 1 is a schematic cross-sectional view of a gas turbine engine;

FIG. 2 is tridimensional view of a portion of a surface cooler;

FIG. 3 is a schematic tridimensional view of a portion of a fan case comprising the surface cooler of FIG. 2;

FIGS. 4a and 4b are schematic cross-sectional views of a portion of the gas turbine engine of FIG. 1 illustrating one embodiment of the recirculation conduit;

FIG. 5 is a schematic cross-sectional view of a portion of the gas turbine engine of FIG. 1 illustrating another embodiment of the recirculation conduit;

FIGS. 6a and 6b are schematic cross-sectional views of a portion of the gas turbine engine of FIG. 1 illustrating yet another embodiment of the recirculation conduit;

FIG. 7 is a graph illustrating the total temperature in function of the radial position across the annular by-pass flow along an axial plane corresponding to an exit of the surface cooler;

FIG. 8 is a graph illustrating the mass-averaged mass flow rate between two consecutive fins in function of the axial position;

FIG. 9 is a graph illustrating the mass-averaged axial velocity between two consecutive fins in function of the axial position;

FIGS. 10a and 10b are entropy contours taken along a cross-section of the annular by-pass flow at the exit of the surface cooler;

FIGS. 11a and 11b are total pressure contours taken along a cross-section of the annular by-pass flow at the exit of the surface cooler; and

FIGS. 12a and 12b are Mach numbers contours taken along a radial plane intersecting with a fin of the surface cooler.

FIGS. 13a and 13b are tridimensional views of a possible embodiment of a surface cooler.

FIG. 14 is a front view of the fan case of FIG. 1 having installed the surface cooler of FIG. 13.

### DETAILED DESCRIPTION

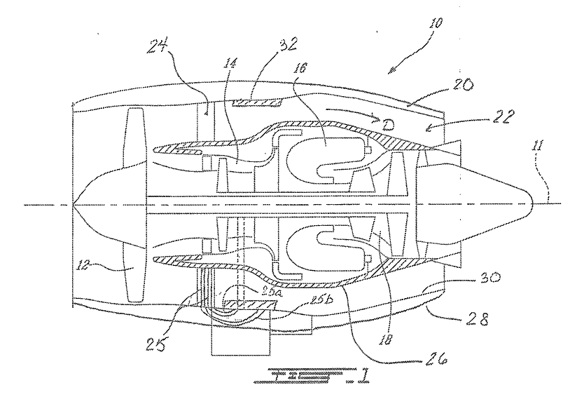

FIG. 1 illustrates a gas turbine engine 10 of a type preferably provided for use in subsonic flight, generally comprising in serial flow communication a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases.

The gas turbine engine 10 further comprises a fan case defining a by-pass duct 22 surrounding the engine core that comprises the compressor 14, combustor 16, and turbine 18. A plurality of struts or vanes 24 are circumferentially disposed around the engine core and extend from a case of the engine core 26 toward the fan case. The struts 24 are disposed downstream of the fan 12 relative to a direction of the flow D. The struts 24 are configured for structurally positioning the fan case wall 30 relative to the engine core case 26.

In a particular embodiment, the engine 10 comprises a radially-outer nacelle wall 28 and a radially-inner fan case wall 30 defined by the fan section 20. The nacelle wall 28 is radially spaced-apart from the fan case wall 30. In a particular embodiment, the gas turbine engine 10 further comprises a surface cooler 32 circumferentially extending around the fan case wall 30. In a particular embodiment, the surface cooler 32 is mounted to the fan case wall 30.

Surface coolers can be used to remove heat from engine air and oil systems and are typically mounted in engine bypass duct 22 where high moving air mass is available. Heat transfer occurs by a process of convection with a flow of air circulating in the by-pass duct 22. Surface cooler thermal performance is thus highly dependent on Reynold no/local Mach number and its total wetted surface area. Surface coolers are more specifically used as air-cool-oil-cooler (ACOC) system and air cooler for the integrated drive gear (IDG) system. The IDG system is used to provide electrical power to the aircraft and has a gear box. Oil of the gear box is cooled with the surface cooler.

For a given bypass Mach number a balance is required for cooler surface area needed for heat rejection relative to the losses generated by skin friction. Others factors such as space restriction, ease of accessibility/installation also dictate the surface cooler geometry and dimensions.

For turbofan engines bypass duct losses can play an important role in engine specific fuel consumption (SFC). The losses in the duct 22 can have a very large exchange change rate to SFC and even be higher than that of fan or the low pressure compressor. It can be a suitable place in the engine where SFC can be readily recovered or reduced. Unfortunately, in reality when mechanical/manufacturing limits are imposed, most by-pass components, such as surface coolers, affect engine SFC.

In a particular embodiment, the gas turbine engine 10 further comprises a fluid recirculation sub-system comprising pipes 25 carrying an engine fluid from the engine core to the surface cooler 32 to be cooled. In one embodiment, the pipes 25 are disposed within a hollow portion of the struts 24. The pipes 25 comprises a first pipe 25a to carry the hot fluid from the engine core to the surface cooler 32. Another pipe 25b is used to carry the hot fluid that has been cooled from the surface cooler 32 back to the engine core. Others mean known in the art may be used without departing from the scope of the present disclosure. Such hot fluid may be lubricating oil or other fluids from systems of the engine 10. Oil is re-circulated through tubes 25 running circumferentially outside of surface cooler fin. The cooler fin on the air side carries heat away by process of convection. Cooled oil is returned to oil tank and is then pumped through pipe 25 to supply oil to bearings.

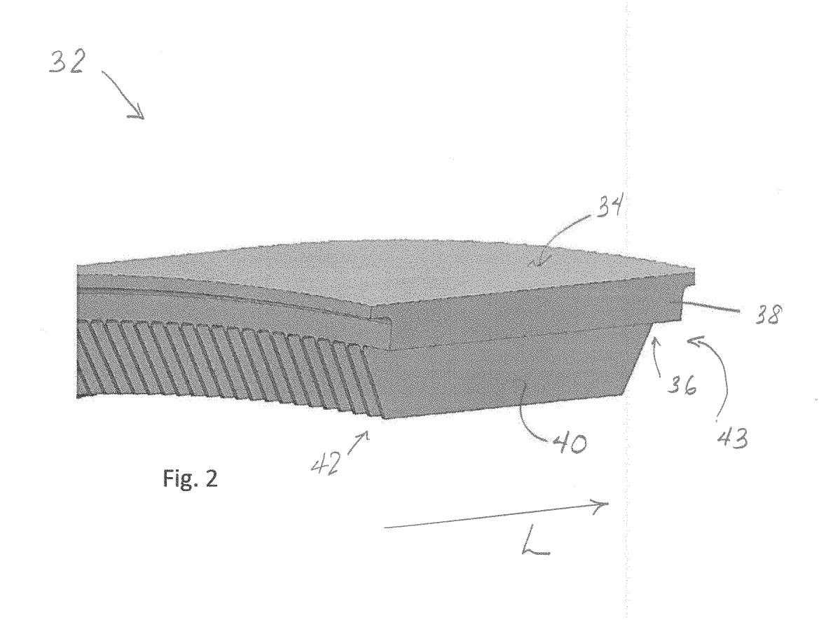

Now referring to FIG. 2, the surface cooler 32 comprises an outer circumferential surface 34, an inner circumferential surface 36 and an annular body 38 extending therebetween. In a particular embodiment, the outer surface 34 is configured for contacting the fan case wall 30. The surface cooler 32 typically comprises a plurality of fins 40 extending along a longitudinal direction L parallel to the axis of rotation 11 of the gas turbine engine 10. The fins 40 protrude inwardly from the inner surface 36 of the annular body 38 of the surface cooler 32 and extend through the by-pass duct 22 toward the engine core case 26. In this embodiment, the annular body 38 of the surface cooler 32 comprises channels (not shown) therein for receiving a hot fluid from the engine core carried by the sub-system 25. Any suitable surface cooler known in the art may be used.

In a particular embodiment, the fins 40 have a rectangular cross-section taken along an axial plane. Any other shape may be used without departing from the scope of the present disclosure. In one embodiment, the surface cooler 32 is circumferentially mounted and extends around the entire circumference of the by-pass duct 22 (over 360 degrees). The surface cooler 32 axially extends to cover a portion, about 30% in this embodiment, of a total length of the fan case wall 30 taken along the longitudinal direction L. In an alternate embodiment, the whole radially-inner fan case wall 30 is covered by the surface cooler 32. In another alternate embodiment, the surface cooler 32 only extends about a portion of the circumference of the fan case wall 30.

Although an attempt is made to make the fins aerodynamics, it remains that the fins of the surface cooler 32 tend to cause the flow in the by-pass duct 22 to lift off pass the leading edge 42 of the surface cooler 32. Such phenomenon in one part leads to mixing loss with the flow of the engine core, but also starves the surface cooler 32 of air when the flow reaches the trailing edge 43 of the surface cooler 32. Indeed, the mass flow rate circulating between two consecutive fins decreases with the direction of the by-pass flow because the flow deviates radially away from the fan case wall 30. The local heat transfer coefficient along the direction of the flow thus decreases since less air is available to receive the heat of the fins 40. A discussion regarding this phenomenon is presented herein below.

A typical remedy is to increase the surface cooler wetted area by increasing fin density, and the dimensions of the fins 40. However, such practice tends to exacerbate the spillage problem thereby leading to even more by-pass performance loss. Furthermore, large spillage flow also creates large back pressure on upstream components of the engine moving them away from their optimum operational position. Moreover, the size of the surface cooler 32 has a direct weight impact since their mounting hardware are made of thick heavy material.

Currently surface coolers are sized based on given Mach number in the by-pass duct 22, the temperature and the pressure in said duct 22, and based on the heat rejection requirements. However, shaping a surface cooler to be more aerodynamic would result in a more expensive machining process. It was found that in at least some embodiments, it was possible to improve the surface cooler performance by bleeding the flow downstream of the surface cooler.

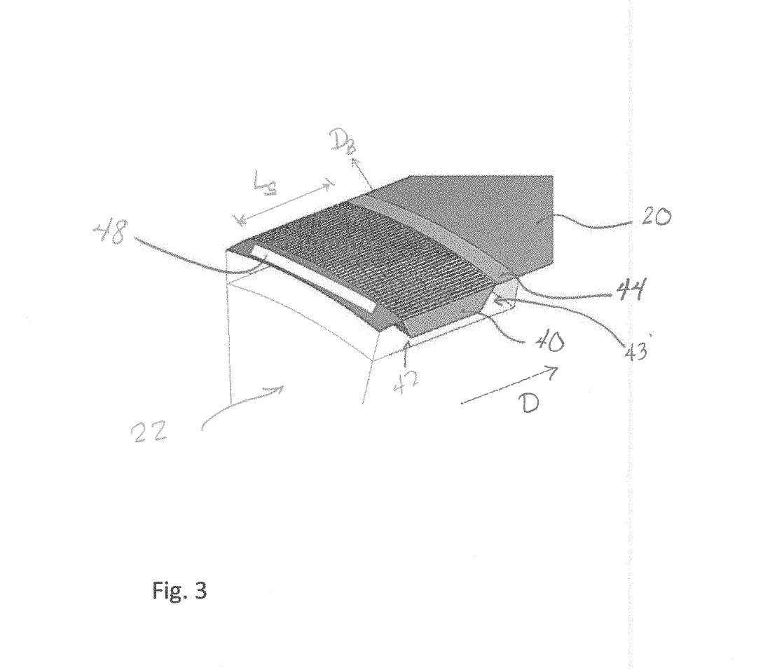

Now referring to FIG. 3, the fan case wall 30 comprises an outlet 44 for bleeding the flow of air of the by-pass duct 22. The outlet 44 is disposed downstream of the surface cooler 32 relative to a direction of the flow D. In a particular embodiment, a distance between the outlet 44 and a trailing edge 43 of the surface cooler 32 is approximately between 1 to 3 times the height of surface cooler fin relative to the radial direction. In a particular embodiment, the outlet 44 is positioned immediately downstream of the surface cooler 32. The outlet 44 thus allows the air to escape through the fan case wall 30 following a bleeding direction D_{B}. Different embodiments of the outlet 44 are discussed herein below.

In a particular embodiment, the fan case wall 30 further defines an inlet 48 for re-injecting the flow that has been extracted from the by-pass duct 22 through the outlet 44. The inlet 48 is located upstream of the surface cooler 32 relative to the direction D. In one embodiment, the inlet 48 is located upstream of the surface cooler 32 and of the struts 24 of the gas turbine engine 10. The inlet 48 present a plurality of possible embodiments that are discussed herein below.

In a particular embodiment, an air pressure of the flow in the by-pass duct 22 varies along the direction of the flow D. Accordingly, by increasing a distance between the inlet 48 and the outlet 44, the pressure differential between the inlet and the outlet increases. Such pressure difference causes the flow downstream of the surface cooler 32 to be sucked in the recirculation conduit 46 through the outlet 44 to be re-injected upstream through the inlet 48. A greater pressure differential thus results in a greater mass flow rate in the recirculation conduit 46.

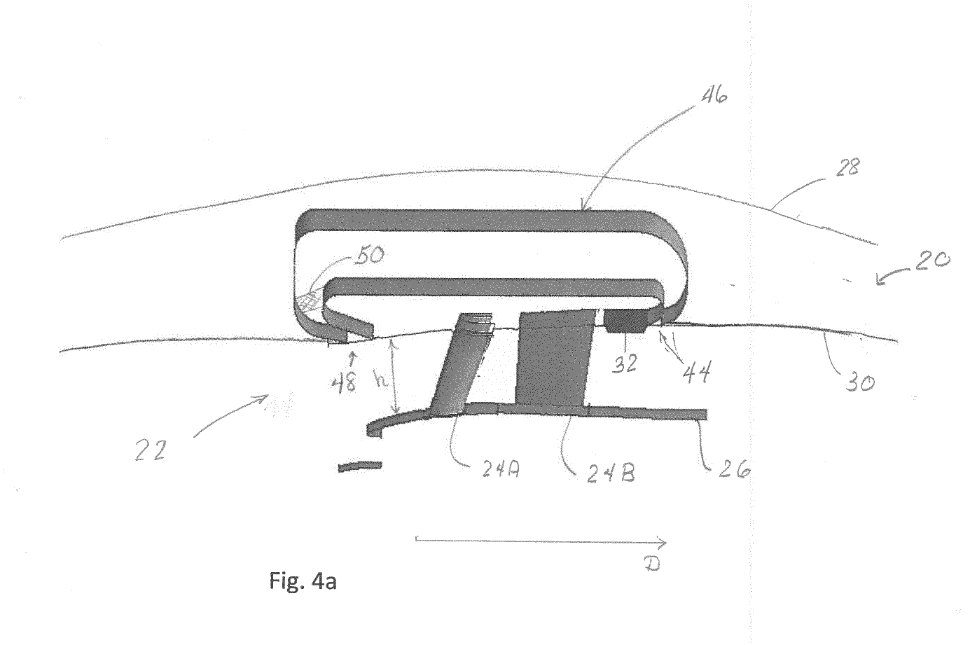

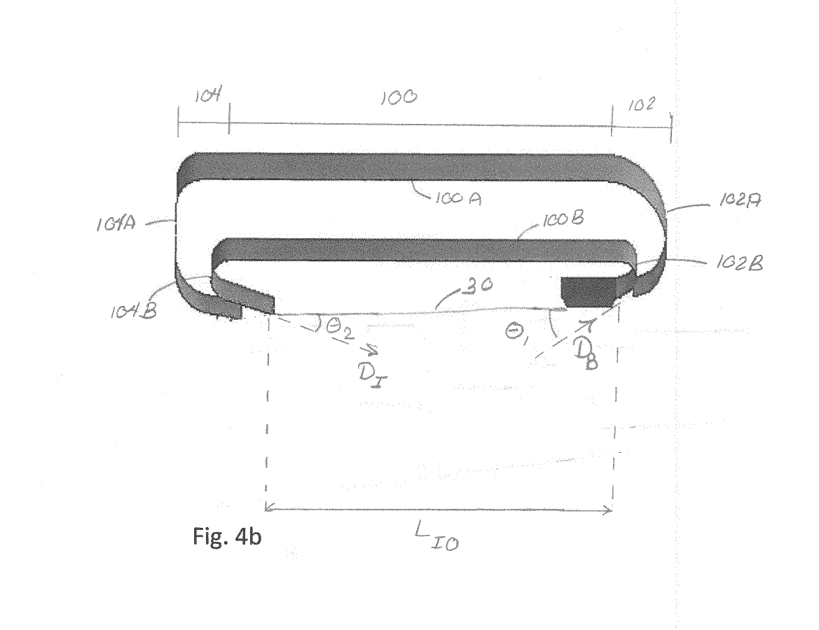

Now referring to FIG. 4a, in a particular embodiment, the surface cooler 32 is disposed downstream of the vanes 24A and of the struts 24B of the gas turbine engine 10. In a particular embodiment, the fan case wall 30 defines an axial gap creating a bleeding slot 44 extending circumferentially around the by-pass duct 22. In a particular embodiment, the bleeding slot 44 extend from the fan case wall 30 to the nacelle wall 28 to provide a fluid connection between two zones of different pressure to suck air from the by-pass duct.

In one embodiment, the bleeding slot 44 is fluidly connected to a recirculation conduit 46. In one embodiment, the recirculation conduit 46 is a cavity circumferentially extending 360 degrees around the by-pass duct and between the fan case wall 30 and the nacelle wall 28 of the fan section 20. In an alternate embodiment, the recirculation conduit can be a cavity extending only partially around the by-pass duct, for instance.

In a particular embodiment, the recirculation conduit comprises guide vanes 50 to guide a flow of the recirculation conduit 46. The guide vanes 50 are disposed across the conduit 46 through the flow circulating therein and have the objective to guide the flow such that a direction of the flow exiting the recirculation conduit 46 is locally parallel to the flow in the by-pass duct 22.

Now referring to FIG. 4b, an isolated view of the cavity 46 of FIG. 4a is shown. In a particular embodiment, the cavity 46 has three portions, a main conduit 100, a bleeding conduit 102, and an injecting conduit 104. The main conduit 100 has two circumferential walls 100A and 100B radially spaced from one another. The main conduit 100 thus extends between the two circumferential walls 100A and 100B.

The bleeding conduit 102 has two walls 102A and 102B axially spaced from one another. The downstream-most wall 102A is a continuity of the circumferential wall 100A of the main conduit 100. Similarly, the upstream-most wall 102B is a continuity of the circumferential wall 100B of the main conduit 100. The radial walls 102A and 102B are angled such that the flow enters at an angle θ₁ relative to the fan case wall 30. The angle θ₁ is smaller than 90 degrees to provide a bleeding direction D_{B} to facilitate extraction of air from the by-pass duct 22. In one embodiment, the angle θ₁ is between 25 degrees and 50 degrees. In another embodiment, the outlet 44 are bleeding apertures, or nozzles, circumferentially distributed downstream of the surface cooler 32 and extending through the inner surface of the fan case wall 30.

The injecting conduit 104 also defines two walls 104A and 104B axially spaced from one another. The upstream-most wall 104A and the downstream-most wall 104B are continuities of the circumferential wall 100A and 100B of the main conduit 100, respectively. In accordance with one embodiment, the upstream-most and downstream-most walls 104A and 104B of the injection conduit 104 are angled such that the exiting flow defines an angle θ₂ relative to the fan case wall 30. The angle θ₂ is also smaller than 90 degrees. In one embodiment, the angle θ₂ is less or equal than 20 degrees. Such angle has the objective to inject the flow at a direction D_{I} substantially parallel to a local direction of the by-pass flow in the by-pass duct 22. In a particular embodiment, a distance between the upstream-most 104A and downstream-most 104B walls of the injection conduit decreases with the direction of the flow D_{I} to accelerate the flow toward its re-entry in the by-pass duct 22.

In a particular embodiment, a ratio between a distance L_{IO} between the inlet and the outlet of the recirculation conduit and the height h of the by-pass duct between the engine core and the radially-inner wall is greater than 2.

Now referring to FIG. 5, in another embodiment, the upstream-most and downstream most walls 104A and 104B of the injection conduit 104 do not extend all the way toward the radially-inner fan case wall 30 thereby leaving a thickness of material T. In this embodiment, the inlet 48 comprises a plurality of circumferentially spaced-apart apertures 52. The apertures 52 are defined through the thickness T of the wall 30. Each apertures 52 re-inject air at the same angle as the local flow angle. In a particular embodiment, each aperture 52 has a cross-sectional area decreasing with a direction of the flow D_{I} in the recirculation conduit 46 to accelerate the flow toward the exit and before its re-entry in the by-pass duct 22. The objective being to reduce a difference in axial velocity between the re-injected flow and the flow in the by-pass duct 22.

In accordance with a particular embodiment, the apertures 52 define an angle a to guide the flow such that a direction of the flow exiting the apertures 52 is parallel to the flow in the by-pass duct 22. The angle a is smaller than 90°. In a particular embodiment, the angle a is between 0° and 20°. In a particular embodiment, a guide vane as described herein above extends in the recirculation conduit 46 across the flow circulating therein.

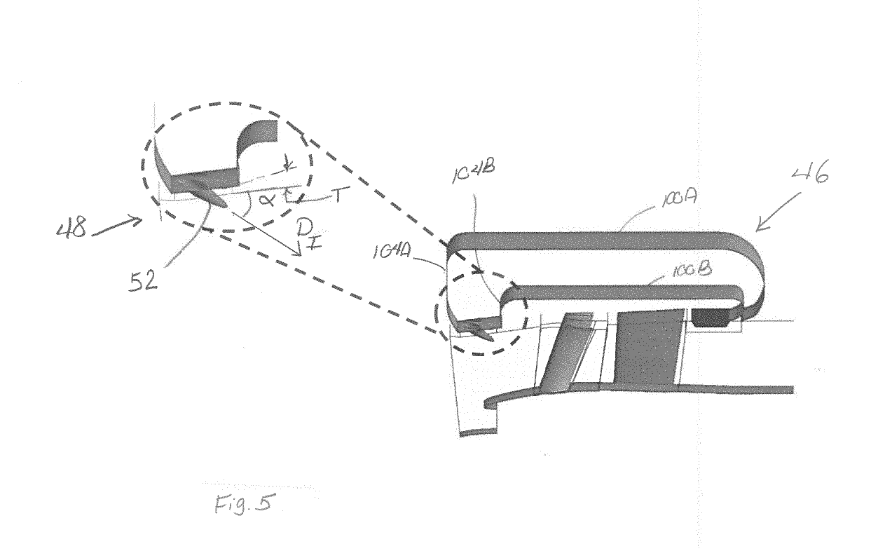

Now referring to FIGS. 6a and 6b, in this embodiment the radially-inner fan case wall 30 defines a radial gap 54. In a particular embodiment, the injecting conduit 104 further has a radially-inner wall section 106 axially extending from the upstream-most wall 104A. The wall section 106 extends downstream beyond an end 56 of the downstream-most wall 104B of the injection conduit 104. An annular conduit 58 is thereby created between the radially-inner fan case wall 30 and the wall section 106. In a particular embodiment, a cross-sectional area of the annular conduit 58 decreases with a direction of the flow D_{C} to accelerate the flow before it exits the recirculation conduit 46.

Accordingly, in such an embodiment, the outlet 48 is an annular surface 60 defined between the wall section 106 and the radially-inner fan case wall 30. In such an embodiment, the flow exits the recirculation conduit 46, and the annular conduit 58, parallel to the fan case wall 30. In a particular embodiment, the annular conduit 58 intersects with the vanes 24A.

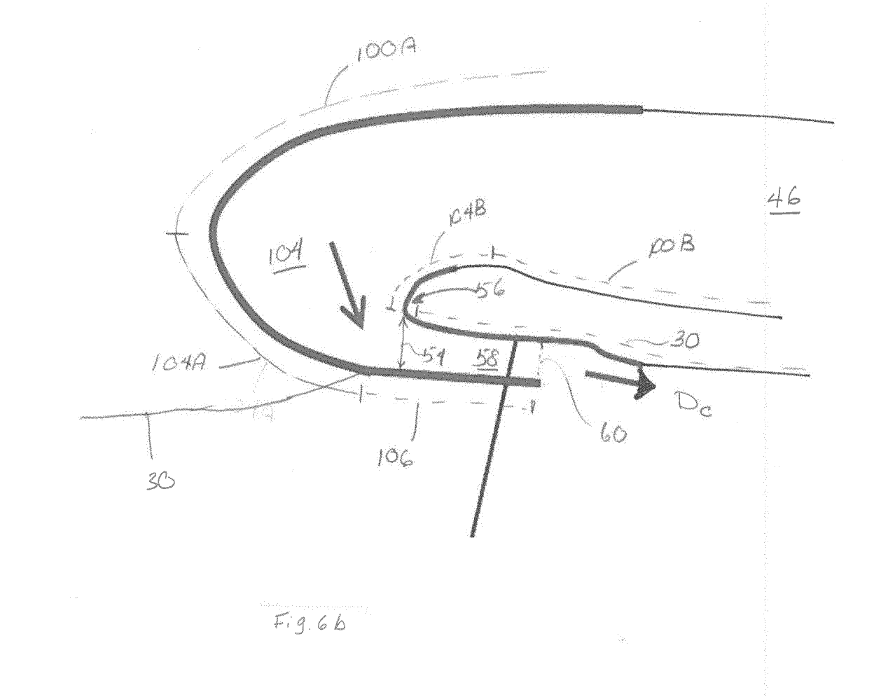

Now referring to FIG. 7, the line C₁ represents a distribution of total temperatures along a radial plane located at an axial position immediately downstream of the surface cooler 32 for a configuration in which the flow is not bled downstream of the surface cooler. The line C₂ represents a distribution of total temperatures along the same radial plane but for a configuration in which the flow is bled downstream of the surface cooler 32. The total temperature T₂ near the fan case wall 30 of the configuration comprising the bleeding of the flow is higher than the total temperature T₁ at the same position. This demonstrates that more heat has been transferred from the fins 40 of the surface cooler 32, and thus from the engine oil, to the air flow circulating in the by-pass duct 22. These results lead to the conclusion that the surface cooler 32 increases in efficiency when flow is bled downstream.

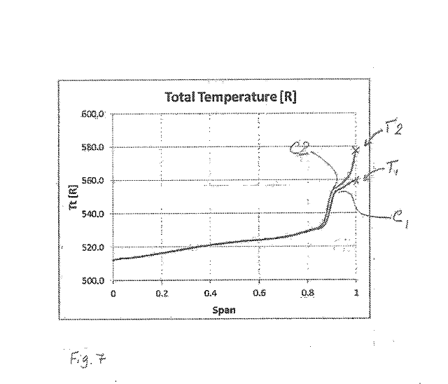

Now referring to FIG. 8, the line M₁ represents the mass-averaged mass flow rate between two adjacent fins of the surface cooler 32 measured along the longitudinal axis 11 of the gas turbine engine 10 for a configuration in which the flow is not bled downstream of the surface cooler 32. The line M₂ represents the same property along the same axis but for a configuration in which the flow is bled downstream of the surface cooler 32. The graph shows that the mass flow rate between two fins is increased when the flow is bled downstream of the surface cooler 32. These results thus demonstrate that more air circulates between the fins 40 since the mass flow rate is increased. A higher mass flow rate thereby increase the heat transfer potential of the surface cooler 32.

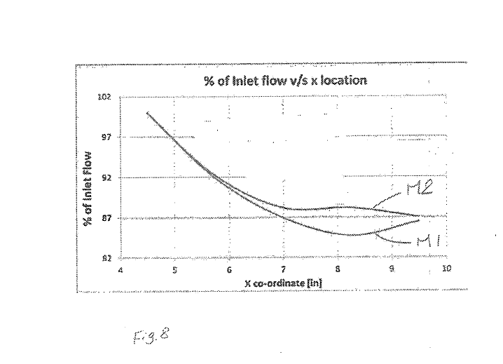

FIG. 9 also leads to the same conclusion. The line V₁ and V₂ represents the mass-averaged axial velocity measured along the longitudinal axis 11 between two adjacent fins 40 for a configuration in which the flow is not bled and for the same configuration but in which the flow is bleed, respectively. The results demonstrate that the axial velocity between two fins is higher when the flow is bled (V₂) compared to the same configuration in which the flow is not bled (V₁). The higher velocity increases the heat transfer potential since the local heat transfer coefficient increases with the velocity.

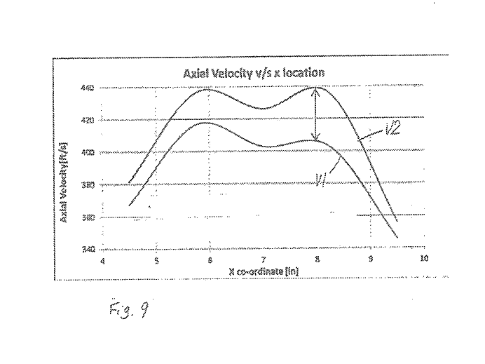

Now referring to FIGS. 10a and 10b, the entropy contours of the configuration without bleeding (FIG. 8A) and with bleeding (FIG. 8B) of the flow in an axial plane of the by-pass duct corresponding to an axial position immediately downstream of the surface cooler 32 are shown. The contours show that less entropy is created, consequently less losses, when the flow is bled downstream of the surface cooler 32.

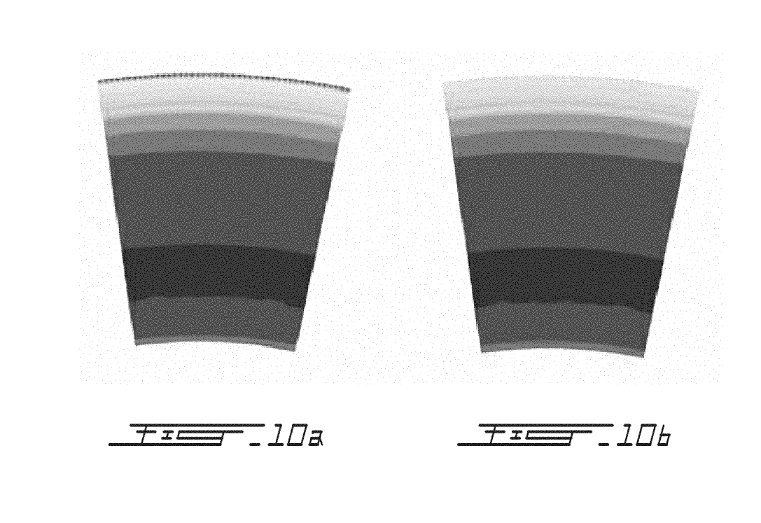

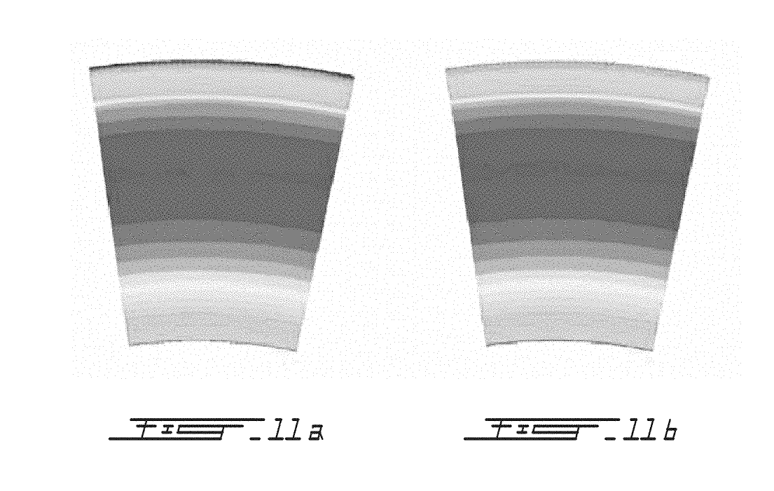

Now referring to FIGS. 11a and 11b, the pressure contours of the configuration without bleeding (FIG. 9A) and with bleeding (FIG. 9B) of the flow in an axial plane of the by-pass duct corresponding to an axial position in which the flow exits the surface cooler 32 are shown. The contours show that less pressure drops are generated when the flow is bled downstream of the surface cooler 32.

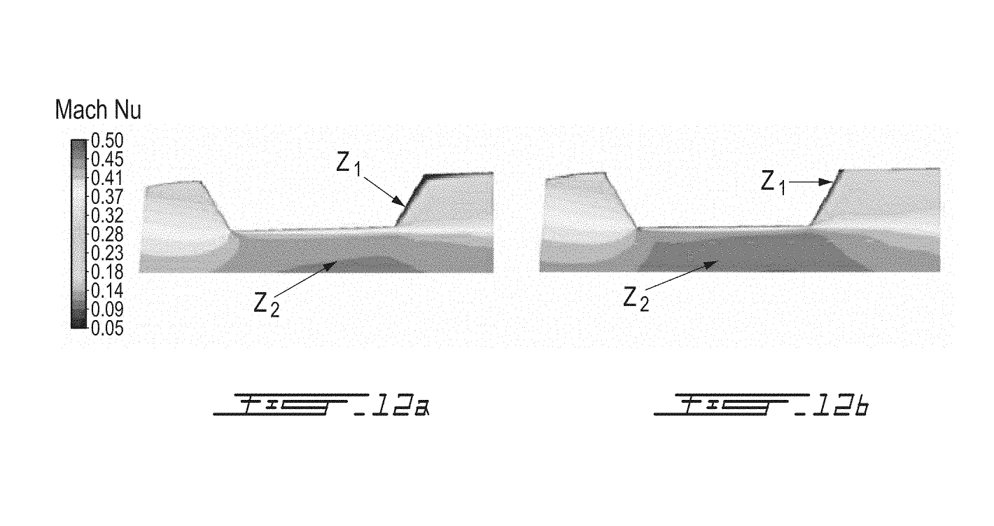

Now referring to FIGS. 12a and 12b, the Mach number contours in a radial plane intersecting one of the fins 40 of the surface cooler 32 are shown. The zone referred to by numerals Z₁ illustrates that the Mach number of the flow exiting the surface cooler is higher when the flow is bled (FIG. 10b) compared to a similar configuration without bleeding (FIG. 10A). The zone referred by numerals Z₂ illustrates that the Mach number is also higher in a configuration in which the flow is bled downstream of the surface cooler 32. Accordingly, the contours demonstrate that the quality of flow around the surface cooler is improved due to increased mass flow and axial velocity downstream of the surface cooler 32. Cleaner flow exiting the surface cooler 32 also reduces boundary layer build up along the fan case wall 30. This is illustrated by the higher Mach number in the zone Z₂.

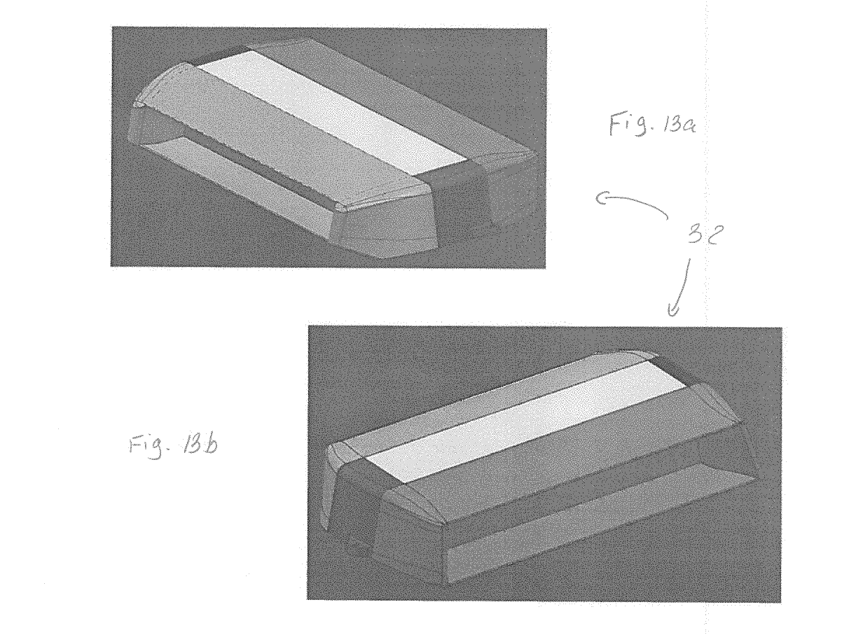

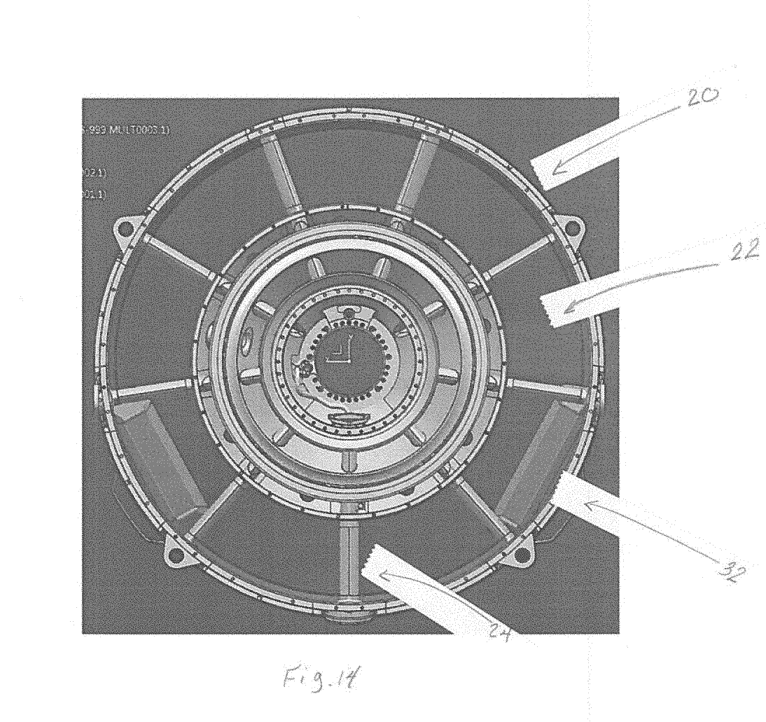

Now referring to FIGS. 13a, 13b, and 14, another possible embodiment of a surface cooler 32 is shown. In this case, the surface cooler 32 is a matrix cooler. The matrix cooler has a longitudinally extending pipe (not sown) disposed within a casing of the matrix cooler and configured to circulate a hot fluid from the engine to be cooled. The pipe is thus in contact by the flow in the by-pass duct 22. In the illustrated embodiment, a matrix cooler 32 is disposed between two consecutive struts or vanes 24.

Referring to all figures, a method for cooling an engine fluid circulating in an engine core of a gas turbine engine 10 is also disclosed. The method comprises the step of receiving a by-pass flow in a by-pass duct 22 defined by a fan case wall 30 surrounding the engine core. Then, heat is transferred from the engine fluid to the by-pass flow by convection with a surface cooler 32 affixed to a radially-inner fan case wall 30. The surface cooler 32 has a plurality of circumferentially spaced-apart, and longitudinally extending fins 40.

The air is also bled downstream of the surface cooler 32 relative to the by-pass flow through an outlet 44 defined through the radially-inner fan case wall 30 and re-injected at a position upstream of the surface cooler 32 through an inlet 48 defined through the radially-inner fan case wall 30. In a particular embodiment, the inlet 48 is fluidly connected to the outlet 44 by a recirculation conduit 46. In one embodiment, the recirculation conduit 46 is a cavity extending between a radially-outer nacelle wall 28 of the fan section 20 and the radially-inner fan case wall 30.

According to a particular embodiment, the method further comprises the step of guiding the extracted air parallel to a local direction of the flow of the by-pass duct 22. In one embodiment, this step is carried by a shape of the recirculation conduit 46 that has an injection conduit 104 oriented toward a direction of the flow in the by-pass duct 22.

In one embodiment, the flow of the recirculation conduit 46 is accelerated before its re-entry in the by-pass duct 22. The injection conduit 104 may have a cross-sectional area decreasing with the direction of the flow. In a particular embodiment, the injection conduit 104 is fluidly connected to a plurality of apertures 52 having a decreasing cross-sectional area along a direction of the flow circulating therein. The apertures are defined through a thickness of the radially-inner fan case wall 30.

In an alternate embodiment, the recirculation conduit radially extend over the radially-outer nacelle wall 28. Also, the recirculation conduit 46 may also be a plurality of pipes axially extending between a position downstream of the surface cooler and a second position upstream of the surface cooler.

In an alternate embodiment, the surface cooler is mounted around the engine core case instead of the fan case. In such an embodiment, the fins of the surface coolers extend outwardly from the engine core case toward the fan case. The recirculation conduit is a cavity extending within the engine core case.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A gas turbine engine, comprising:
an engine core having a compressor, a turbine, a combustor, and a rotation axis;
a fan case wall extending circumferentially and having a radially-inner surface;
a by-pass duct between the fan case wall and the engine core,
a plurality of struts circumferentially distributed and extending across the by-pass duct;
a surface cooler adjacent to the radially-inner surface of the fan case wall and configured to be exposed to a by-pass air flow through the by-pass duct during operation of the gas turbine engine, the surface cooler fluidly communicating with a fluid circuit of the engine requiring cooling of a fluid; and
a recirculation conduit extending between an inlet in the radially-inner surface of the fan case wall disposed downstream of the surface cooler and an outlet in the radially-inner surface of the fan case wall disposed upstream of the surface cooler.

2. The gas turbine engine according to claim 1, wherein the recirculation conduit is a cavity circumferentially extending within the fan case wall, and wherein the surface cooler circumferentially extends around the rotation axis.

3. The gas turbine engine according to claim 1, wherein the inlet of the recirculation conduit is an axial gap in the radially-inner surface.

4. The gas turbine engine according to claim 1, wherein the outlet of the recirculation conduit is an axial gap in the radially-inner surface.

5. The gas turbine engine according to claim 1, wherein the outlet is provided in the form of a plurality of circumferentially distributed nozzles defined through the fan case wall.

6. The gas turbine engine according to claim 5, wherein each of the plurality of nozzles define an acute angle relative to the rotation axis.

7. The gas turbine engine according to claim 1, wherein the outlet of the recirculation conduit is a radial gap in the radially-inner surface, the recirculation conduit forming an intermediary section of the radially-inner surface of the fan case wall, an annular conduit being defined between the fan case wall and the intermediary section, a cross-sectional area of the annular conduit decreasing with a direction of a flow circulating therein.

8. The gas turbine engine according to claim 1, wherein the outlet of the recirculation conduit defines an acute angle relative to the rotation axis.

9. The gas turbine engine according to claim 1, wherein the surface cooler has a plurality of fins, and wherein a distance along a direction of the by-pass air flow between a trailing edge of the surface cooler and the inlet of the recirculation conduit is equal to or lower than three times a height of one of the plurality of fins relative to a radial direction.

10. The gas turbine engine according to claim 1, wherein the surface cooler is disposed downstream of the plurality of struts relative to the by-pass air flow.

11. The gas turbine engine according to claim 1, wherein the outlet of the recirculation conduit is upstream of the plurality of struts relative to the by-pass air flow.

12. A fan case assembly of a gas turbine engine, comprising:
a fan case wall circumferentially extending around a longitudinal axis of the gas turbine engine and having a radially-inner surface;
a recirculation conduit circumferentially extending between an inlet and an outlet defined in the fan case wall, the inlet disposed downstream of the outlet, the recirculation conduit configured to deliver by-pass air from the inlet to the outlet; and
a surface cooler mounted adjacent the radially-inner surface between the inlet and the outlet, the surface cooler communicating with a fluid circuit of the engine requiring cooling of a fluid.

13. The fan case assembly according to claim 12, wherein the inlet of the recirculation conduit is an axial gap in the radially-inner surface.

14. The fan case assembly according to claim 12, wherein the outlet of the recirculation conduit is an axial gap in the radially-inner surface.

15. The fan case assembly according to claim 12, wherein the outlet of the recirculation conduit is a radial gap in the radially-inner surface.

16. The fan case assembly according to claim 15, the recirculation conduit forming an intermediary section of the radially-inner surface, an annular conduit being defined between the fan case wall and the intermediary section, a cross-sectional area of the annular conduit decreasing with a direction of a flow circulating therein.

17. A method for cooling an engine fluid circulating in an engine core of a gas turbine engine, comprising:
receiving a by-pass flow in a by-pass duct defined by a fan case wall surrounding the engine core;
transferring heat from the engine fluid to the by-pass flow by convection with a surface cooler adjacent to a radially-inner surface of the fan case wall;
bleeding the by-pass flow downstream of the surface cooler through an outlet in the radially-inner surface; and
recirculating an extracted portion of the by-pass flow and injecting it back into the by-pass flow at a position upstream of the surface cooler through an inlet in the radially-inner surface, the inlet being fluidly connected to the outlet by a recirculation conduit.

18. The method of claim 17, further comprising guiding the extracted portion parallel to a local direction of the by-pass flow before the step of injecting the extracted portion upstream of the surface cooler.

19. The method of claim 17, further comprising accelerating the extracted portion before the step of injecting the extracted portion upstream of the surface cooler.
